(19) United States
(12) Patent Application Publication
(10) Pub. No.: US 2020/0184483 A1
(43) Pub. Date: Jun. 11, 2020

(54) ABNORMALITY DETECTION APPARATUS, CONTROL METHOD, AND PROGRAM

(71) Applicant: NEC CORPORATION, Tokyo (JP)

(72) Inventors: Jianquan LIU, Tokyo (JP); Shoji NISHIMURA, Tokyo (JP); Yasufumi HIRAKAWA, Tokyo (JP)

(73) Assignee: NEC CORPORATION, Tokyo (JP)

(21) Appl. No.: 16/342,298

(22) PCT Filed: Jul. 27, 2017
(86) PCT No.: PCT/JP2017/027219

§ 371 Date: Apr. 16, 2019

(30) Foreign Application Priority Data
Oct. 17, 2016 (JP) 2016-203929

(51) Int. Cl. G06Q 20/42; G06Q 40/02; G06Q 20/40

(52) U.S. Cl. CPC G06Q 20/42; G06Q 20/4014; G06Q 40/02

(57) ABSTRACT

An acquisition unit (2020) acquires a combination of person information and transaction information for a first transaction. The person information is information representing a person who executes a transaction. The transaction information is various kinds of information regarding the transaction. A storage device (10) stores transaction information of each transaction. Using the person information of the first transaction acquired by the acquisition unit (2020), a detection unit (2040) acquires transaction information of a transaction (second transaction), which is executed by a person having a high degree of similarity with a person who executes the first transaction, from the storage device (10). The detection unit (2040) detects an abnormal transaction using the transaction information of the first transaction and the transaction information of the second transaction.

### TECHNICAL FIELD

The present invention relates to an abnormality detection apparatus, a control method, and a program.

### BACKGROUND ART

Illegal transactions using bank cash cards or credit cards are a problem. For example, Patent Document 1 is a document that discloses a related art relevant to such an illegal transaction. Patent Document 1 discloses an apparatus that detects that an abnormal transaction of a game currency is performed in a game account. For example, in a case where the same item is sold a predetermined number of times or more in the same account, the account is determined to be an account in which an abnormal transaction is performed.

### RELATED DOCUMENT

### Patent Document

[Patent Document 1] Japanese Patent Application Publication No. 2014-535097

[Patent Document 2] WO 2014/109127A

[Patent Document 3] Japanese Patent Application Publication No. 2015-49574

### SUMMARY OF THE INVENTION

### Technical Problem

The apparatus disclosed in Patent Document 1 determines whether or not a transaction is abnormal for each account. However, for example, in a case where a single person has a plurality of accounts, it is conceivable that an abnormality of a transaction cannot be detected by focusing on transactions performed by one account.

The present invention has been made in view of the above problems. One of the objects of the present invention is to provide a technique for detecting an abnormal transaction with high accuracy.

### Solution to Problem

An abnormality detection apparatus of the present invention includes (1) an acquisition unit that acquires a first combination including two or more types of feature data having uniqueness and (2) a detection unit that acquires a second combination, which includes two or more types of feature data having uniqueness and includes feature data having a high degree of similarity with the feature data included in the first combination, and detects an abnormal state using the feature data included in the first combination and the feature data included in the second combination.

A control method of the present invention is executed by a computer. The control method includes (1) an acquisition step of acquiring a first combination including two or more types of feature data having uniqueness and (2) a detection step of acquiring a second combination, which includes two or more types of feature data having uniqueness and includes feature data having a high degree of similarity with the feature data included in the first combination, and detecting an abnormal state using the feature data included in the first combination and the feature data included in the second combination.

A program of the present invention causes a computer to execute each step of the control method of the present invention.

### Advantageous Effects of Invention

According to the present invention, there is provided a technique for detecting an abnormal transaction with higher accuracy.

### BRIEF DESCRIPTION OF THE DRAWINGS

The aforementioned object and other objects, features, and advantages will become more apparent from preferred embodiments described below and the following accompanying diagrams.

FIG. 1 is a block diagram illustrating an abnormality detection apparatus of Example embodiment 1.

FIG. 2 is a diagram conceptually illustrating the operation of the abnormality detection apparatus of Example embodiment 1.

FIG. 3 is a diagram illustrating a computer for realizing an abnormality detection apparatus.

FIG. 4 is a flowchart illustrating the flow of the process executed by the abnormality detection apparatus of Example embodiment 1.

FIG. 5 is a diagram illustrating an index for hierarchizing persons detected from a plurality of captured images.

FIG. 6 is a flowchart illustrating the flow of a first method for acquiring transaction information of a second transaction.

FIG. 7 is a flowchart illustrating the flow of a process for determining a person having a high degree of similarity with a person who has performed a first transaction using the index shown in FIG. 5.

FIG. 8 is a diagram illustrating the association between person information and transaction information in a table format.

FIG. 9 is a flowchart illustrating the flow of the process executed in S106.

### DESCRIPTION OF EMBODIMENTS

Hereinafter, an example embodiment of the present invention will be described with reference to the diagrams. In all the diagrams, the same components are denoted by the same reference numerals, and will not be repeated. In each of the block diagrams, unless otherwise specified, each block represents not the configuration of a hardware unit but the configuration of a functional unit.

### Example Embodiment 1

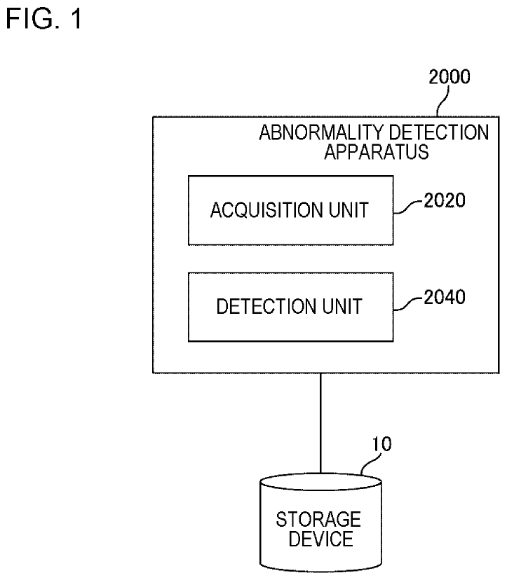

FIG. 1 is a block diagram illustrating an abnormality detection apparatus 2000 of Example embodiment 1. The abnormality detection apparatus 2000 has an acquisition unit 2020 and a detection unit 2040. The acquisition unit 2020 acquires a combination of person information and transaction information for the first transaction. The person information is information representing a person who executes a transaction. For example, the person information is a feature value that is computed based on a captured image, in which the person is captured, and represents the feature of the physical appearance of the person (for example, the feature of a face.) The transaction information is various kinds of information regarding the transaction. For example, the transaction is a transaction to withdraw cash from a bank account. In this case, the transaction information includes, for example, the account number of the bank account, the name information of the bank account, date and time at which the transaction was executed, and a place where the transaction was executed. Details of the transaction or the transaction information will be described later.

A storage device 10 stores transaction information of each transaction. Using the person information of the first transaction acquired by the acquisition unit 2020, the detection unit 2040 acquires transaction information of a transaction, which is executed by a person having a high degree of similarity with the person who executes the first transaction, from the storage device 10. The transaction relevant to the transaction information acquired herein is referred to as second transaction. The detection unit 2040 detects an abnormal transaction using the transaction information of the first transaction and the transaction information of the second transaction.

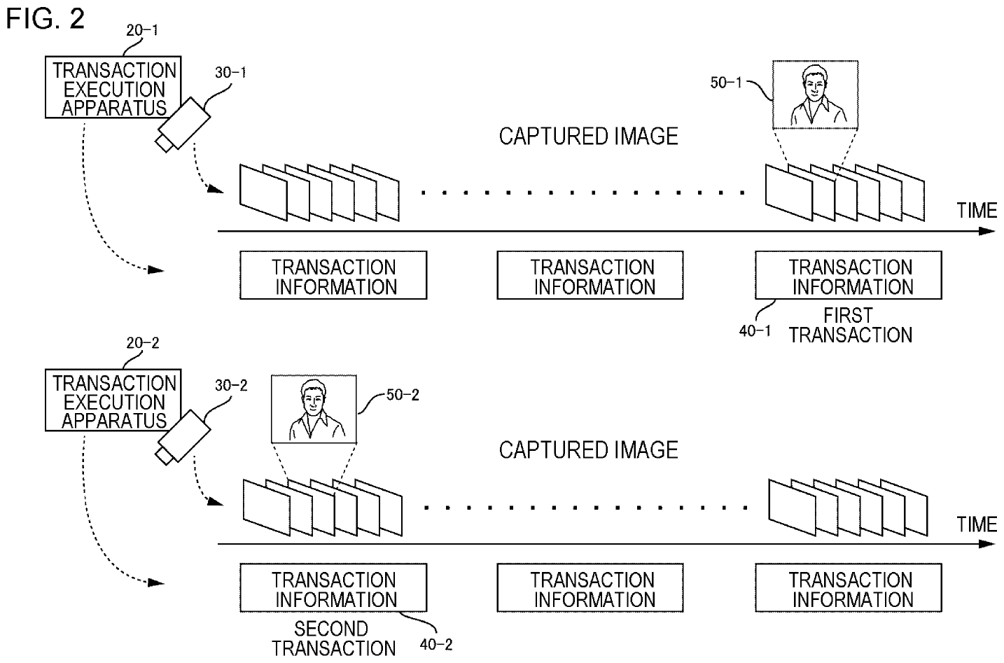

FIG. 2 is a diagram conceptually illustrating the operation of the abnormality detection apparatus 2000 of Example embodiment 1. A transaction execution apparatus 20-n (n is a positive integer) is an apparatus used to execute a transaction. In a case where the transaction is a transaction to withdraw cash from the bank account, the transaction execution apparatus 20-n is an auto teller machine (ATM) installed in, for example, a bank or a convenience store. Note that, hereinafter, the transaction execution apparatus 20-n is simply denoted as transaction execution apparatus 20 when explaining matters common to each transaction execution apparatus.

A camera 30-n (n is a positive integer) is a camera (for example, a surveillance camera) installed in the vicinity of the transaction execution apparatus 20-n. The camera 30 is installed so as to image a person who performs a transaction. Note that, hereinafter, the camera 30-n is simply denoted as camera 30 when explaining matters common to each camera.

In FIG. 2, there are a transaction execution apparatus 20-1 and a transaction execution apparatus 20-2 that are installed in two different places (for example, different convenience stores). A person who executes a transaction using the transaction execution apparatus 20-1 is imaged by a camera 30-1, and a person who executes a transaction using the transaction execution apparatus 20-2 is imaged by a camera 30-2. Each of the camera 30-1 and the camera 30-2 generates a sequence of the captured image (for example, a video) by repeatedly imaging.

In this example, the abnormality detection apparatus 2000 acquires transaction information 40-1 of the first transaction executed by the transaction execution apparatus 20-1 and a captured image 50-1 in which a person executing the first transaction is captured. The abnormality detection apparatus 2000 computes the feature value of the person executing the first transaction by analyzing the person included in the captured image 50-1. The abnormality detection apparatus 2000 uses the computed feature value as the person information of the person who executes the first transaction.

Using the feature value of the person who executes the first transaction, the abnormality detection apparatus 2000 acquires transaction information 40 of a transaction, which is executed by a person having a high degree of similarity with the person, from the storage device 10. In the example shown in FIG. 2, it is assumed that a person included in the captured image 50-2 is determined to be a person having a high degree of similarity with the person who executes the first transaction. In this case, the abnormality detection apparatus 2000 acquires transaction information 40-2 of a transaction executed by the person included in the captured image 50-2. This transaction is handled as the second transaction described above.

The abnormality detection apparatus 2000 detects an abnormal transaction using the transaction information 40-1 and the transaction information 40-2.

Here, the operation of the abnormality detection apparatus 2000 described with reference to FIG. 2 is an example for facilitating the understanding of the abnormality detection apparatus 2000, and does not limit variations in the configuration or operation of the abnormality detection apparatus 2000. For example, in the example shown in FIG. 2, the first transaction and the second transaction are executed by different transaction execution apparatuses 20. However, these may be transactions executed by the same transaction execution apparatus 20. Note that, hereinafter, the transaction information 40-n is simply denoted as transaction information 40 when explaining matters common to each transaction information.

<Advantageous Effect>

According to the abnormality detection apparatus 2000 of the present example embodiment, an abnormality of a transaction is detected based on the transaction information of the first transaction executed by a certain person and the transaction information of the second transaction executed by a person having a high degree of similarity with the person. As described above, since the abnormality detection apparatus 2000 uses information of a plurality of transactions executed by a person having a high degree of similarity, it is possible to detect the abnormality of each transaction, for example, even in a case where these transactions use different bank accounts (accounts of banks). Therefore, compared with a method of detecting the abnormality of a transaction based only on transactions using one account, it is possible to detect the abnormality of a transaction with higher accuracy.

Hereinafter, the present example embodiment will be described in more detail.

<Example of Hardware Configuration of Abnormality Detection Apparatus 2000>

Each functional component of the abnormality detection apparatus 2000 may be realized by hardware (for example, a hard-wired electronic circuit) that realizes each functional component, or may be realized by a combination of hardware and software (for example, a combination of an electronic circuit and a program for controlling the electronic circuit). Hereinafter, a case where each functional component of the abnormality detection apparatus 2000 is realized by the combination of hardware and software will be further described.

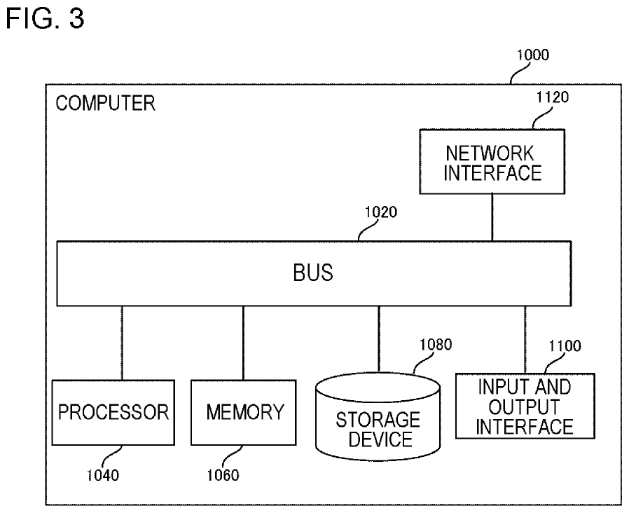

FIG. 3 is a diagram illustrating a computer 1000 for realizing the abnormality detection apparatus 2000. The computer 1000 is a variety of computers. For example, the computer 1000 is a personal computer (PC), a server machine, or a mobile terminal (a tablet terminal or a smartphone). The computer 1000 may be a dedicated computer designed to realize the abnormality detection apparatus 2000, or may be a general-purpose computer.

The computer 1000 has a bus 1020, a processor 1040, a memory 1060, a storage device 1080, an input and output interface 1100, and a network interface 1120. The bus 1020 is a data transmission line through which the processor 1040, the memory 1060, the storage device 1080, the input and output interface 1100, and the network interface 1120 transmit and receive data to and from each other. The processor 1040 is an arithmetic processing apparatus, such as a central processing unit (CPU) or a graphics processing unit (GPU). The memory 1060 is a primary storage device formed by a random access memory (RAM) or the like. The storage device 1080 is a secondary storage device formed by a hard disk, a solid state drive (SSD), a ROM, a memory card, or the like. However, the storage device 1080 may be formed by a RAM.

The input and output interface 1100 is an interface for connecting the computer 1000 to an input and output device. For example, an input device, such as a keyboard or a mouse, or an output device, such as a display apparatus, is connected to the input and output interface 1100.

The network interface 1120 is an interface for connection with a communication network, such as a wide area network (WAN) or a local area network (LAN).

The storage device 1080 stores program modules for realizing each function of the abnormality detection apparatus 2000. The processor 1040 reads these program modules into the memory 1060 and executes the program modules, thereby realizing the respective functions corresponding to the program modules.

<Process Flow>

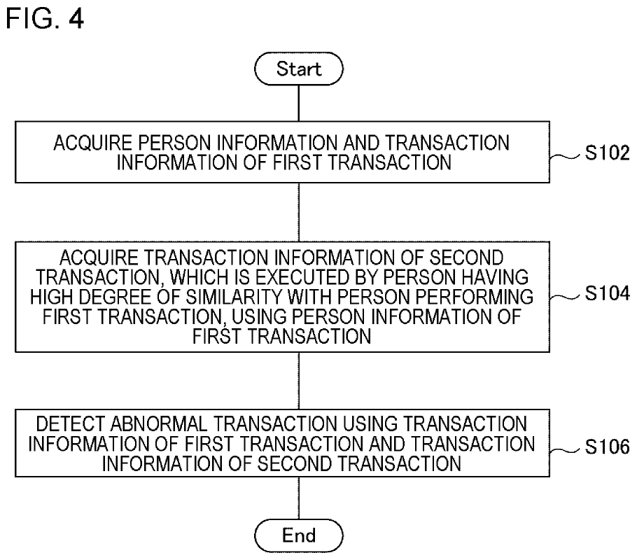

FIG. 4 is a flowchart illustrating the flow of the process executed by the abnormality detection apparatus 2000 of Example embodiment 1. The acquisition unit 2020 acquires person information and transaction information of the first transaction (S102). The detection unit 2040 acquires transaction information of the second transaction using the person information of the first transaction (S104). The detection unit 2040 detects an abnormal transaction using the transaction information of the first transaction and the transaction information of the second transaction (S106).

<Timing at which Abnormality Detection Apparatus 2000 Operates>

The series of processes (process illustrated in FIG. 4) by the abnormality detection apparatus 2000 described above may be performed during the execution of the first transaction or may be performed after the first transaction is performed. In the latter case, for example, the abnormality detection apparatus 2000 handles each transaction performed during the past predetermined period as a first transaction and performs the series of processes. In this manner, the abnormality detection apparatus 2000 detects an abnormal transaction from transactions performed during the predetermined period. For example, the abnormality detection apparatus 2000 handles each transaction performed on a certain day as a first transaction and performs batch processing on the next day, thereby determining whether or not each transaction is normal.

In another example, the abnormality detection apparatus 2000 may execute the series of processes according to the user's input operation. For example, the user performs an input for specifying a period, in which an abnormal transaction may be performed, with respect to the abnormality detection apparatus 2000. The abnormality detection apparatus 2000 handles each transaction performed during the period as a first transaction, and repeats the series of processes. In this manner, the abnormality detection apparatus 2000 detects an abnormal transaction from transactions performed during the specified period. For example, in a case where a user is requested a cooperation by an administrative organization, such as police, due to the occurrence of an incident of abusing an account, the user performs an input for specifying a period relevant to the incident with respect to the abnormality detection apparatus 2000, so that an abnormal transaction is detected from transactions performed during the period.

<Transaction Handled by Abnormality Detection Apparatus 2000>

The abnormality detection apparatus 2000 can handle various transactions. The transaction handled by the abnormality detection apparatus 2000 is, for example, a transaction using an account. In this case, transaction information includes one or more of the identifier of the account used in the transaction, the name information of the account used in the transaction, the point in time at which the transaction is performed, and the place where the transaction is performed. The name information of the account is, for example, the name, address, or date of birth of the user of the account.

As the account, various things can be handled. For example, the account is a bank account. The transaction in this case is, for example, withdrawing cash from the bank account or a payment using a debit card. In this case, the identifier of the account is, for example, the account number of a bank account.

In another example, the account is an account of a credit card. The transaction in this case is, for example, a payment using a credit card or cashing. In this case, the identifier of the account is, for example, a credit card number.

In another example, the account is a membership service account. The transaction in this case is, for example, shopping using a membership card (for example, payment for a product using points or payment for a product to which a membership discount is applied). In this case, the identifier of the account is, for example, a membership number.

<Example of Computer 1000 for Realizing Abnormality Detection Apparatus 2000>

Various things can be adopted as the specific computer 1000 for realizing the abnormality detection apparatus 2000. For example, the computer 1000 is realized as a transaction execution apparatus (transaction execution apparatus 20 shown in FIG. 2) used for execution of a transaction. In a case where the transaction is a transaction using a bank account, the transaction execution apparatus is, for example, an ATM handling a transaction relevant to the bank account or a point of sales (POS) terminal used for payment using a debit card. In a case where the transaction is a transaction using an account of a credit card, the transaction execution apparatus is, for example, an ATM handling a transaction relevant to the credit card or a POS terminal used for payment using the credit card. In a case where the transaction is a transaction using a membership service account, the transaction execution apparatus is, for example, a POS terminal used for payment for a product using a membership card.

The computer 1000 may be an apparatus different from the transaction execution apparatus. In this case, for example, the computer 1000 is a server machine used for management of the transaction execution apparatus. In another example, the computer 1000 may be a computer that is prepared separately from the transaction execution apparatus or the above-described server machine in order to realize the abnormality detection apparatus 2000.

In a case where the transaction execution apparatus 20 is used as the computer 1000 for realizing the abnormality detection apparatus 2000, each transaction execution apparatus 20 handles a transaction executed by that transaction execution apparatus 20 itself as a first transaction, thereby detecting an abnormal transaction. On the other hand, in a case where an apparatus other than the transaction execution apparatus 20 is used as the computer 1000 for realizing the abnormality detection apparatus 2000, the abnormality detection apparatus 2000 handles transactions executed by one or more transaction execution apparatuses 20 as first transactions, thereby detecting an abnormal transaction.

<About Storage Device 10>

The storage device 10 is any storage device that can acquire and store transaction information. The abnormality detection apparatus 2000 is communicably connected to the storage device 10. The storage device 10 may be provided inside the abnormality detection apparatus 2000, or may be provided outside the abnormality detection apparatus 2000. In the former case, for example, the storage device 10 is realized as the storage device 1080 shown in FIG. 3. In the latter case, for example, the storage device 10 is realized as a network attached storage (NAS).

<Acquisition of Information Regarding First Transaction: S102>

The acquisition unit 2020 acquires person information and transaction information of the first transaction. Hereinafter, a method of acquiring person information and a method of acquiring transaction information will be described.

<<Method of Acquiring Person Information>>

The abnormality detection apparatus 2000 acquires a captured image in which a person executing the first transaction is captured, for example, as described above. In addition, the abnormality detection apparatus 2000 computes the feature value of the person executing the first transaction by analyzing the captured image. For example, the feature value represents a feature of the face. The acquisition unit 2020 acquires the computed feature value as person information. Here, a well-known technique can be used as a technique for computing the feature value of a person included in an image.

Here, the camera 30 for imaging a person executing the first transaction may be a camera that generates a video, or may be a camera that captures a still image. In the former case, the captured image acquired by the abnormality detection apparatus 2000 is an image frame that forms the video.

The abnormality detection apparatus 2000 can use any method to acquire a captured image. For example, the abnormality detection apparatus 2000 acquires a captured image by accessing a storage device in which the captured image is stored. The storage device in which the captured image is stored may be provided inside the camera 30 that has generated the captured image, or may be provided outside the camera 30. In another example, the abnormality detection apparatus 2000 may acquire a captured image by receiving the captured image transmitted from the camera 30 or the like.

Note that, the processing for computing the feature value of the person included in the captured image may be performed by an apparatus other than the abnormality detection apparatus 2000. In this case, the acquisition unit 2020 acquires the feature value, as the person information of the person who executes the first transaction, from the apparatus that has computed the feature value described above.

<<Acquisition of Transaction Information of First Transaction>>

There are various methods in which the acquisition unit 2020 acquires the transaction information of the first transaction. Hereinafter, the explanation is divided into a case where the timing at which the abnormality detection apparatus 2000 performs a series of processes is at a timing when the first transaction has been executed, and a case where that is at a timing after the first transaction is finished.

<<<Case in which Abnormality Detection Apparatus 2000 Operates when First Transaction has been Executed>>>

The abnormality detection apparatus 2000 acquires transaction information of the first transaction from the transaction execution apparatus used for execution of the first transaction. Here, it is assumed that the abnormality detection apparatus 2000 is realized as a transaction execution apparatus. In this case, the abnormality detection apparatus 2000 acquires the transaction information of the first transaction generated inside the abnormality detection apparatus 2000.

On the other hand, it is assumed that the abnormality detection apparatus 2000 is realized as an apparatus other than the transaction execution apparatus. In this case, the transaction execution apparatus transmits the transaction information of the first transaction to the abnormality detection apparatus 2000 during the execution of the first transaction (for example, immediately after the start of the first transaction). The abnormality detection apparatus 2000 receives the transaction information transmitted by the transaction execution apparatus.

<<<Case in which Abnormality Detection Apparatus 2000 Operates after First Transaction Finished>>>

The abnormality detection apparatus 2000 acquires the transaction information of the first transaction from the storage device 10. For example, it is assumed that the abnormality detection apparatus 2000 handles each of a plurality of transactions performed in the past as a first transaction and executes the series of processes. In this case, for example, the abnormality detection apparatus 2000 sequentially reads transaction information from the storage device 10, and handles the read transaction information as the transaction information of the first transaction and performs the series of processes. Note that, the transaction information may be read in any order.

<<Method of Combining Person Information and Transaction Information>>

The acquisition unit 2020 acquires a combination of person information and transaction information of the first transaction. For example, person information and transaction information are combined based on the generation date and time of the captured image used for generation of the person information and the transaction date and time shown in the transaction information. More specifically, for example, transaction information is combined with person information having the generation date and time of a captured image used to generate the person information, which is closest to the transaction date and time of the transaction information, among a plurality of pieces of person information. In another example, transaction information is combined with person information having the generation date and time of a captured image used to generate the person information, which is a point in time between the transaction start date and time and the transaction completion date and time of the transaction information, among a plurality of pieces of person information. In this case, the transaction information indicates both the transaction start date and time and the transaction completion date and time.

<Acquisition of Transaction Information of Second Transaction: S104>

The detection unit 2040 acquires transaction information of a transaction performed by a person having a high degree of similarity with the person who has performed the first transaction, using the person information of the person who has performed the first transaction (S104). The number of pieces of transaction information acquired by the detection unit 2040 may be one or more. In the latter case, a plurality of transactions are handled as second transactions.

In a case where the person information indicates the feature value of the person, the detection unit 2040 acquires transaction information of a transaction performed by a person having a feature value with a high degree of similarity with the feature value of the person who performs the first transaction. Hereinafter, each of (1) method of determining a feature value having a high degree of similarity with the feature value of the person who performs the first transaction and (2) method of determining transaction information of a transaction performed by a person having the feature value will be described.

<<Method of Determining Feature Value Having High Degree of Similarity with Feature Value of Person Who Performs First Transaction>>

As a method of determining a feature value having a high degree of similarity with the feature value of the person who performs the first transaction, various methods can be adopted.

Two specific methods are illustrated below.

<<<First Method>>>

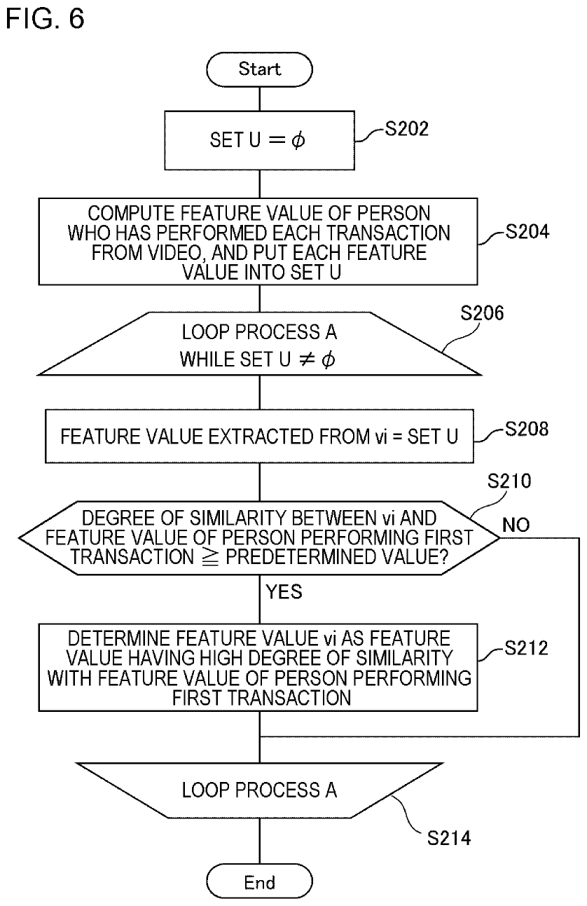

FIG. 6 is a flowchart illustrating the flow of the first method for acquiring transaction information of a second transaction. The detection unit 2040 initializes a set U, which is to be used in subsequent processing, to an empty set (S202). The detection unit 2040 computes a feature value of the person who has performed each transaction by analyzing a video (for example, a video in a past predetermined period) in which a place where the transaction has been performed is imaged, and puts each computed feature value into the set U (S204). Here, the detection unit 2040 may analyze a plurality of videos in which different places are imaged (refer to FIG. 2). For example, in the case of handling a transaction relevant to a bank account, the detection unit 2040 analyzes a plurality of videos generated by imaging a plurality of ATMs. However, the video to be analyzed may be only a video in which one place is imaged.

S206 to S214 are a loop process A executed for each feature value included in the set U. In S206, the detection unit 2040 determines whether or not an element is included in the set U. In a case where an element is included in the set U, the process shown in FIG. 6 proceeds to S208. On the other hand, in a case where no element is included in the set U, the process shown in FIG. 6 is ended.

In S208, the detection unit 2040 extracts one feature value of a person who has performed the transaction from the set U. The extracted feature value is denoted as vᵢ. The detection unit 2040 determines whether or not the degree of similarity between the feature value of the person performing the first transaction and the feature value vᵢ extracted from the set U is equal to or greater than a predetermined value (S210). In a case where the degree of similarity between the feature value of the person performing the first transaction and vᵢ is less than the predetermined value (S210: NO), the process shown in FIG. 6 proceeds to S214.

On the other hand, in a case where the degree of similarity between the feature value of the person performing the first transaction and vᵢ is equal to or greater than the predetermined value (S210: YES), the detection unit 2040 determines the feature value vᵢ as the feature value of the person performing the first transaction.

Since S214 is the end of the loop process A, the process shown in FIG. 6 returns to S206. Thereafter, the loop process A is repeatedly executed until there is no element in the set U.

<<<Second Method>>>

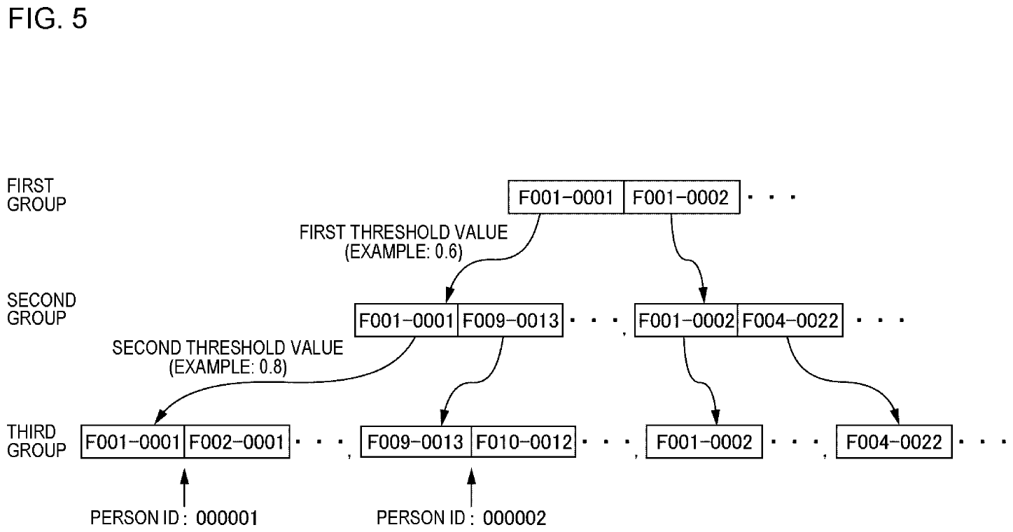

In this method, the abnormality detection apparatus 2000 analyzes a video in which a place where a transaction is performed is imaged, and indexes the feature value of a detected person as shown in FIG. 5. Here, the number of videos to be analyzed may be one or more. In the latter case, the plurality of videos may include videos captured at different places. Then, using the index, the abnormality detection apparatus 2000 determines a person having a high degree of similarity with the person who performs the first transaction. By using the index, it is possible to increase the processing speed. The details of the index and the generation method are disclosed in Patent Documents 2 and 3. Hereinafter, the structure of the index shown in FIG. 5 and its usage will be briefly described.

The index shown in FIG. 5 hierarchies persons detected from a plurality of captured images. Here, a unique identifier (ID) is assigned to each person detected from the captured image. This ID is called a detection ID. For example, in FIG. 5, F0001-0001, F0001-0002, and the like are detection IDs. Here, it is assumed that the index shown in FIG. 5 is generated in advance.

In the third layer, nodes corresponding to all the detection IDs obtained from all the captured images processed so far are arranged. The plurality of nodes arranged in the third layer are grouped such that those having a degree of similarity of the feature value equal to or greater than a predetermined value with each other belong to the same group. One group in the third layer represents, for example, a group in which detection IDs of persons estimated to be the same person are collected. Therefore, in FIG. 5, a person ID that is a unique ID is assigned to each group of the third layer.

In the second layer, one node (representative node) selected from each of the plurality of groups of the third layer is arranged. The representative node is linked with a group of the third layer to which the representative node belongs. The plurality of nodes arranged in the second layer are grouped such that those having a degree of similarity of the feature value equal to or greater than a predetermined value with each other belong to the same group. Note that, the reference of the degree of similarity in the grouping of the third layer (second threshold value) is higher than the reference of the degree of similarity in the grouping of the second layer (first threshold value.)

In the first layer, one node (representative node) selected from each of the plurality of groups of the second layer is arranged. The representative node is linked with a group of the second layer to which the representative node belongs.

Note that, it is preferable that the above-described index is generated in advance before the processing of the abnormality detection apparatus 2000 shown in FIG. 4 is executed. For example, the above-described index is generated and updated by periodically analyzing each video, in which a place where a transaction is performed is imaged, at predetermined periods.

The processing for generating and updating the index may be performed by the abnormality detection apparatus 2000 or may be performed by another apparatus. However, the index may be generated in S104 of FIG. 4.

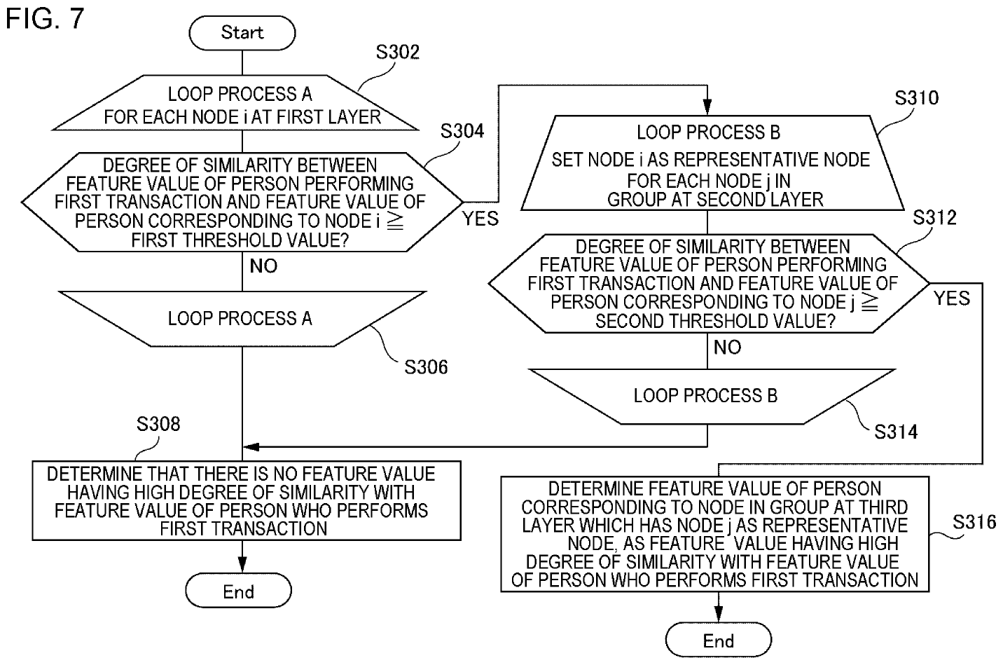

Next, a method of determining a person having a high degree of similarity with the person who has performed the first transaction, using the index shown in FIG. 5 will be described. FIG. 7 is a flowchart illustrating the flow of a process for determining a person having a high degree of similarity with the person who has performed the first transaction using the index shown in FIG. 5.

The detection unit 2040 executes a loop process A (S302 to S306) for each node of the first layer. In S302, the detection unit 2040 determines whether or not there is a node of the first layer that is not yet a target of the loop process A. In a case where there is a node of the first layer that is not yet a target of the loop process A, the detection unit 2040 selects one of the nodes of the first layer that is not yet a target of the loop process A. The node of the first layer selected herein is called a node i. Then, the process shown in FIG. 7 proceeds to S304. On the other hand, in a case where the loop process A has already been executed for all the nodes of the first layer, the process shown in FIG. 7 proceeds to S308.

The detection unit 2040 determines whether or not the degree of similarity between the feature value of the person performing the first transaction and the feature value of a person corresponding to the node i is equal to or greater than the first threshold value (S304). In a case where the degree of similarity described above is equal to or greater than the first threshold value (S304: YES), the process shown in FIG. 7 proceeds to S310. Accordingly, the loop process A is ended.

On the other hand, in a case where the degree of similarity described above is less than the first threshold value (S304: NO), the process shown in FIG. 7 proceeds to S306. Since S306 is the end of the loop process A, the process shown in FIG. 7 proceeds to S302.

As described above, in a case where the loop process A has already been executed for all the nodes of the first layer in S302, the process shown in FIG. 7 proceeds to S308. In S308, the detection unit 2040 determines that there is no feature value having a high degree of similarity with the feature value of the person who performs the first transaction among the feature values of persons who performed transactions in the past. Then, the process shown in FIG. 7 is ended.

S310 to S314 are a loop process B executed for one group in the second layer. This group is a group having the node i of the first layer, for which it is determined that the computed degree of similarity is equal to or greater than the first threshold value in S306, as a representative node.

In S312, the detection unit 2040 determines whether or not there is a node, which is not yet a target of the loop process B, in the group to be processed. In a case where there is a node that is not yet a target of the loop process B, the detection unit 2040 selects one of the nodes that is not yet a target of the loop process B. The node selected herein is called a node j. Then, the process shown in FIG. 7 proceeds to S312. On the other hand, in a case where the loop process B has already been executed for all the nodes included in the group to be processed, the process shown in FIG. 7 proceeds to S308.

In S312, the detection unit 2040 determines whether or not the degree of similarity between the feature value of the person performing the first transaction and the feature value of a person corresponding to the node j is equal to or greater than the second threshold value (S312). In a case where the degree of similarity described above is equal to or greater than the second threshold value (S312: YES), the process shown in FIG. 7 proceeds to S316. Accordingly, the loop process B is ended.

On the other hand, in a case where the degree of similarity described above is less than the second threshold value (S312: NO), the process shown in FIG. 7 proceeds to S314. Since S314 is the end of the loop process B, the process shown in FIG. 7 proceeds to S310.

In S316, processing is performed for one group in the third layer. This group is a group of the third layer having the node j of the second layer, for which it is determined that the computed degree of similarity is equal to or greater than the second threshold value in S312, as a representative node. The detection unit 2040 determines the feature value of the person corresponding to the node included in the group of the third layer as a feature value having a high degree of similarity with the feature value of the person who performs the first transaction.

<<Method of Determining Transaction Information of Transaction Performed by Person Having Certain Feature Value>>

The detection unit 2040 acquires transaction information of a transaction, which is performed by a person having the feature value determined by the first method or the second method described above, from the storage device 10. The transaction information acquired herein is handled as transaction information of the second transaction.

Transaction information of a transaction performed by a person having a certain feature value can be determined based on, for example, the generation date and time of a captured image used for computation of the feature value and the transaction date and time of the transaction information. The specific method is the same as the above-described method of combining person information and transaction information.

An association between a feature value (person information) and transaction information of a person that are computed from a video may be generated in advance and stored in the storage device 10. For example, processing for generating the association is periodically executed at predetermined periods. An apparatus that performs this association may be the abnormality detection apparatus 2000 or may be an apparatus different from the abnormality detection apparatus 2000.

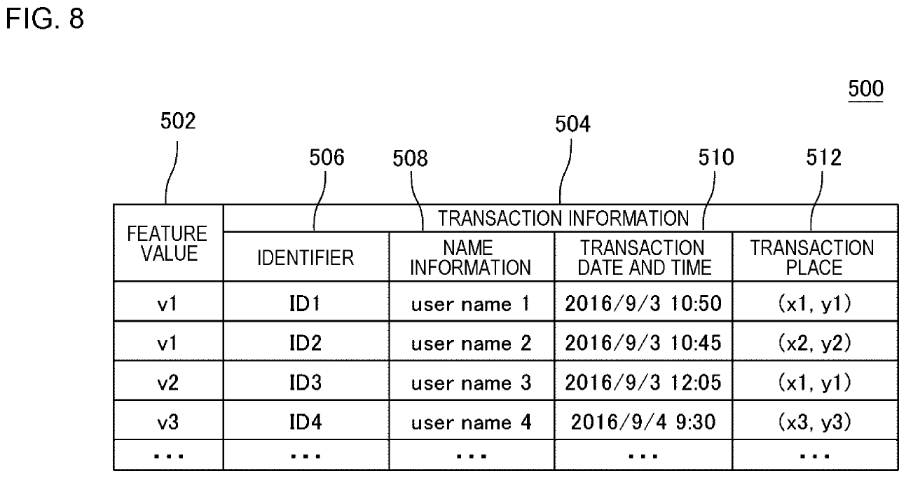

FIG. 8 is a diagram illustrating the association between person information and transaction information in a table format. The table shown in FIG. 8 is denoted as a table 500. The table 500 has two columns of a feature value 502 and transaction information 504. The feature value 502 is person information indicating the feature value of a person who has performed a transaction. The transaction information 504 indicates transaction information.

The transaction information 504 includes an identifier 506, name information 508, transaction date and time 510, and a transaction place 512. The identifier 506 indicates an identifier of an account (for example, an account number of a bank account). The name information 508 indicates name information of an account (for example, the name or the address of a holder of a bank account). The transaction date and time 510 indicates the date and time at which a transaction was performed. The transaction place 512 indicates a place where a transaction was performed. For example, the transaction place 512 indicates the address or the global positioning system (GPS) coordinates of a place where a transaction was performed.

In the case of using the table 500, the detection unit 2040 performs a search on the table 500 with the feature value determined by the first method or the second method described above, thereby acquiring transaction information of a transaction performed by a person having the feature value.

<Detection of Abnormal Transaction: S106>

The detection unit 2040 detects an abnormal transaction using the transaction information of the first transaction and the transaction information of the second transaction (S106). For example, the detection unit 2040 detects an abnormal transaction based on a difference in the transaction place or the identifier of an account indicated by each piece of transaction information. Specifically, predetermined conditions for determining that there is an abnormal transaction are set in advance.

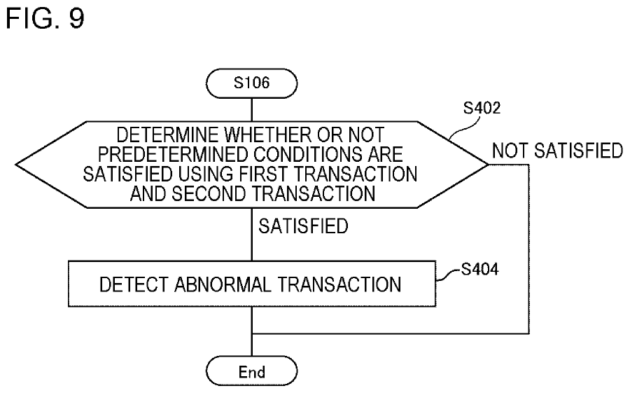

FIG. 9 is a flowchart illustrating the flow of the process executed in S106. The detection unit 2040 determines whether or not the predetermined conditions described above are satisfied using the transaction information of the first transaction and the second transaction (S402). In a case where the conditions are satisfied, the detection unit 2040 detects an abnormal transaction (S404). On the other hand, in a case where the conditions are not satisfied, no abnormal transaction is detected and the process shown in FIG. 9 is ended.

Note that, in S404, the detection unit 2040 may detect an individual transaction, such as the first transaction or the second transaction, as an abnormal transaction, or may only determine that “an abnormal transaction has been detected” without determining individual transactions.

Hereinafter, some examples of conditions for detecting an abnormal transaction will be illustrated.

<<Conditions 1>>

The detection unit 2040 detects an abnormal transaction in a case where the conditions that “a predetermined number or more of transactions in which pieces of name information of accounts are different are present among the first transactions and the second transactions” are satisfied. “Pieces of name information of accounts are different” means that the names of users of accounts are different, for example. It is preferable that the predetermined number is, for example, three or more. In this case, two or more second transactions are present.

In this case, for example, in a case where persons estimated to be the same perform transactions using a plurality of accounts whose names are different from each other, abnormal transactions are detected. It is considered that it is not common that a single person performs transactions using a plurality of accounts whose names are different from each other. Therefore, the abnormality detection apparatus 2000 detects abnormal transactions in a case where such uncommon transactions are performed.

<<Conditions 2>>

The detection unit 2040 detects an abnormal transaction in a case where the conditions that “a predetermined number or more of transactions in which types of accounts are the same and identifiers of the accounts are different are present among the first transactions and the second transactions” are satisfied. The situation “types of accounts are the same” is, for example, a situation in which all accounts are accounts of the same bank, a situation in which all accounts are accounts of the same credit card, or a situation in which all accounts are accounts under the same membership service. It is preferable that the predetermined number is, for example, three or more. In this case, two or more second transactions are present.

In order to compare the types of accounts, for example, information indicating the type of each account is included in transaction information. However, in a case where information for distinguishing the type of each account (for example, a numerical value of a predetermined digit) is included in the identifier of the account, information indicating the type of the account may not be additionally included in the transaction information.

In this case, for example, in a case where persons who seem to be the same withdraws cash using a large number of bank accounts in the same bank, abnormal transactions are detected. It is considered that it is not common that the same person performs transactions using a large number of bank accounts in the same bank. Therefore, the abnormality detection apparatus 2000 detects abnormal transactions in a case where such uncommon transactions are performed.

In this case, even in a case where name information is not included in the transaction information (for example, in a case where a counterfeit card is used), it is possible to detect an abnormal transaction.

<<Other Additional Conditions>>

The detection unit 2040 may add conditions that “the difference between the transaction date and time of the first transaction and the transaction date and time of the second transaction is within a predetermined time” to each of the conditions described above. This is because a case where transactions using accounts with different names or different identifiers are performed within a short period of time (for example, within several hours) is more likely to involve an abnormal transaction than a case where these transactions are performed within a long period of time.

The detection unit 2040 may add conditions that “the distance between the transaction date and time of the first transaction and the transaction place of the second transaction is equal to or greater than a predetermined distance” to each of the conditions described above. This is because a case where transactions using accounts with different names or different identifiers are performed at distant places (for example, places several tens of kilometers away) is more likely to involve abnormal transactions than a case where these transactions are performed at close places.

Both the conditions that “the distance between the transaction date and time of the first transaction and the transaction place of the second transaction is equal to or greater than a predetermined distance” and the conditions that “the difference between the transaction date and time of the first transaction and the transaction date and time of the second transaction is within a predetermined time” may be added to each of the conditions described above.

<Measures in Case where Abnormal Transaction is Detected>

There are various measures in a case where an abnormal transaction is detected by the detection unit 2040. For example, in a case where an abnormal transaction is detected, the transaction execution apparatus 20 the transaction execution apparatus stops the first transaction. In this manner, it is possible to prevent the occurrence of damage due to an abnormal transaction. Note that, in this case, a series of processes by the abnormality detection apparatus 2000 are executed at a timing at which the first transaction is performed.

Note that, in a case where the abnormality detection apparatus 2000 is realized by an apparatus other than the transaction execution apparatus 20, the abnormality detection apparatus 2000 notifies the transaction execution apparatus 20 that an abnormal transaction has been detected. The transaction execution apparatus 20 stops the first transaction in response to the notification.

In another example, in a case where an abnormal transaction is detected, the abnormality detection apparatus 2000 transmits a warning to a server that manages the transaction execution apparatus 20 or a mobile terminal of an administrator of the transaction execution apparatus 20. It is preferable that the warning includes a captured image, in which the person who performs the first transaction is imaged, or transaction information of the first transaction. As a technique for transmitting a warning to a server or a mobile terminal, a well-known technique can be used. In this case, a series of processes by the abnormality detection apparatus 2000 may be executed while the first transaction is being performed, or may be executed after the first transaction is finished.

In another example, in a case where an abnormal transaction is detected, the abnormality detection apparatus 2000 may notify a predetermined organization of the abnormal transaction. At the time of this notification, it is preferable that a captured image in which the person who performs the first transaction is imaged or transaction information of the first transaction is transmitted to the organization. The predetermined organization is an organization managing an account of a transaction determined to be abnormal (such as a bank or a credit card company) or an administrative organization such as a police. In this case, a series of processes by the abnormality detection apparatus 2000 may be executed while the first transaction is being performed, or may be executed after the first transaction is finished.

While the example embodiment of the present invention has been described with reference to the diagrams, these are only illustration of the present invention, and other various configurations may also be adopted.

This application claims priority from Japanese Patent Application No. 2016-203929, filed on Oct. 17, 2016, the entire contents of which are incorporated herein.

1. An abnormality detection apparatus, comprising:
an acquisition unit that acquires a first combination including two or more types of feature data having uniqueness; and
a detection unit that acquires a second combination, which includes two or more types of feature data having uniqueness and includes feature data having a high degree of similarity with the feature data included in the first combination, and detects an abnormal state using the feature data included in the first combination and the feature data included in the second combination.

2. The abnormality detection apparatus according to claim 1,
wherein the acquisition unit acquires a combination of person information representing a person executing a first transaction and transaction information regarding the first transaction, and
the detection unit performs: acquiring transaction information of a second transaction from a storage device that stores the transaction information of each transaction using the acquired person information, the second transaction being executed by a person having a high degree of similarity with the person executing the first transaction; and detecting an abnormal transaction using transaction information of the first transaction and transaction information of the second transaction.

3. The abnormality detection apparatus according to claim 2,
wherein the detection unit performs: determining a captured image, in which a person having a high degree of similarity with the person executing the first transaction is imaged, among a plurality of captured images in which persons performing respective transactions are imaged; and determining the transaction information of the second transaction among a plurality of pieces of transaction information stored in the storage device based on a time at which the captured image is generated.

4. The abnormality detection apparatus according to claim 2,
wherein the abnormality detection apparatus is communicably connected to a storage device that stores the person information representing a person executing each transaction in association with the transaction information of the transaction, and
the detection unit acquires transaction information associated with the person information of a person having a high degree of similarity with the person executing the first transaction, as the transaction information of the second transaction, from the storage device.

5. The abnormality detection apparatus according to claim 2, wherein the detection unit detects an abnormal transaction during an execution of the first transaction.

6. The abnormality detection apparatus according to claim 2, wherein the person information indicates a feature value of a person executing the transaction, the feature value being computed using a captured image in which the person is imaged.

7. The abnormality detection apparatus according to claim 2,
wherein the transaction is a transaction using an account, and
the transaction information includes one or more of an identifier of the account used in the transaction, name information of the account used in the transaction, a point in time at which the transaction is performed, and a place where the transaction is performed.

8. The abnormality detection apparatus according to claim 7,
wherein the account is a bank account, and
the transaction information includes one or more of an identifier of the bank account used in the transaction, name information of the bank account used in the transaction, a point in time at which the transaction is performed, and a place where the transaction is performed.

9. The abnormality detection apparatus according to claim 7, wherein the detection unit determines that there is an abnormal transaction in a case where the first transaction and the second transactions include a predetermined number or more of transactions whose pieces of name information of accounts are different from each other.

10. The abnormality detection apparatus according to claim 7, wherein the detection unit determines that there is an abnormal transaction in a case where the first transaction and the second transactions include a predetermined number or more of transactions whose types of accounts are the same as each other but identifiers of the accounts are different from each other.

11. A control method executed by a computer, the method comprising:
acquiring a first combination including two or more types of feature data having uniqueness;
acquiring a second combination, which includes two or more types of feature data having uniqueness and includes feature data having a high degree of similarity with the feature data included in the first combination; and
detecting an abnormal state using the feature data included in the first combination and the feature data included in the second combination.

12. The control method according to claim 11,
wherein a combination of person information representing a person executing a first transaction and transaction information regarding the first transaction is acquired, and
the control method further comprises:
acquiring transaction information of a second transaction from a storage device that stores the transaction information of each transaction using the acquired person information; and
detecting an abnormal transaction using transaction information of the first transaction and transaction information of the second transaction, the second transaction being executed by a person having a high degree of similarity with the person executing the first transaction.

13. The control method according to claim 12, further comprising:
determining a captured image in which a person having a high degree of similarity with the person executing the first transaction is imaged, among a plurality of captured images in which persons performing respective transactions are imaged; and
determining the transaction information of the second transaction among a plurality of pieces of transaction information stored in the storage device based on a time at which the captured image is generated.

14. The control method according to claim 12,
wherein the computer is communicably connected to a storage device that stores the person information representing a person executing each transaction in association with the transaction information of the transaction, and
the control method further comprises acquiring transaction information associated with the person information of a person having a high degree of similarity with the person executing the first transaction, as the transaction information of the second transaction from, the storage device.

15. The control method according to claim 12, further comprising detecting an abnormal transaction during an execution of the first transaction.

16. The control method according to claim 12, wherein the person information indicates a feature value of a person executing the transaction, the feature value being computed using a captured image in which the person is imaged.

17. The control method according to claim 12,
wherein the transaction is a transaction using an account, and
the transaction information includes one or more of an identifier of the account used in the transaction, name information of the account used in the transaction, a point in time at which the transaction is performed, and a place where the transaction is performed.

18. The control method according to claim 17,
wherein the account is a bank account, and
the transaction information includes one or more of an identifier of the bank account used in the transaction, name information of the bank account used in the transaction, a point in time at which the transaction is performed, and a place where the transaction is performed.

19. The control method according to claim 17, further comprising: determining that there is an abnormal transaction in a case where the first transaction and the second transactions include a predetermined number or more of transactions whose pieces of name information of accounts are different from each other.

20. The control method according to claim 17, further comprising: determining that there is an abnormal transaction in a case where the first transaction and the second transactions include a predetermined number or more of transactions whose types of accounts are the same as each other but identifiers of the accounts are different from each other.

21. A non-transitory computer-readable storage medium storing a program causing a computer to execute each step of the control method according to claim 11.
